(19) United States
(12) Patent Application Publication
(10) Pub. No.: US 2012/0084219 A1
(43) Pub. Date: Apr. 5, 2012

(54) Consolidated Annual Sustainability System and Method

(76) Inventor: John Esson, Hampton, VA (US)

(21) Appl. No.: 13/253,948

(22) Filed: Oct. 5, 2011

Related U.S. Application Data
(60) Provisional application No. 61/390,183, filed on Oct. 5, 2010.

(51) Int. Cl. G06Q 99/00

(52) U.S. Cl. 705/317

(57) ABSTRACT

A consolidated annual sustainability tracking system includes a mitigation tracking system for entering data into a database, tracking mitigation and monitoring commitments, and prompting a user with reminders for the mitigation and monitoring commitments. The system generates reports using data from the database. The reports may be periodic, annual, or on-demand and consolidate the requirements of multiple regulatory schemes to prevent unnecessarily duplicative record-keeping and reporting. The system is designed to work with regulatory schemes such as NEPA, LEEDS, Executive Order 13514, EMS, and similar laws, regulations, requirements, and guidance motivated by concerns relating to environmentalism, sustainability, and energy efficiency. The system is also designed to accommodate and incorporate the requirements of new regulatory schemes as they arise.

### COPENDING APPLICATION

This application claims priority benefit of Provisional Patent Application No. 61/390,183, filed Oct. 5, 2010, titled “MITIGATING TRACKING SYSTEM AND METHOD” having the same inventor of the instant patent application and which is incorporated herein by reference as if set forth in full below.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

I. Field

This invention relates to software tools for monitoring environmental policy compliance.

II. Background

The National Environmental Protection Act of 1969 (“NEPA” or the “Act”) is a United States law which created procedural requirements all federal government agencies must follow when preparing Environmental Assessments (an “EA” or multiple “EAs”) and Environmental Impact Statements (an “EIS” or multiple “EISs”). An agency proposing an action which is covered by NEPA generally must produce an EA prior to commencing the action. An EA is a document which summarizes the significance of the environmental impact of a proposed action. If no substantial effects on the environment are found, the agency may produce a Finding of No Significant Impact (“FONSI”). Conversely, if the EA indicates that further evaluation is necessary, the agency produces an EIS to detail the environmental impact of the proposed action. After preparation and review of the EA or EIS, the agency prepares a decision document stating whether the proposed action is approved.

Currently, compliance with NEPA is burdensome to agency resources. Federal facilities have had long-term, chronic problems with delays and cost overruns on proposed actions. Proposals for minor or moderate actions nearly always lead to a FONSI, causing NEPA compliance to be wasteful of time and money. Further, the cumulative impact of these small projects is not adequately analyzed. Due to these burdens and the procedural difficulties associated with NEPA compliance, agencies have to focus on the procedural requirements of producing the necessary documents rather than focusing on the outcome or solution-based motives behind the requirements, such as those to improve and maintain the environment and make better environmental decisions.

NEPA documents quickly become obsolete, often by the time the decision document is signed. When a planned action changes, previously created NEPA documents become irrelevant and new NEPA documents must be prepared reflecting the changes. A process is needed to allow adaptive management of the project and the environmental performance while ensuring transparency with public accountability.

Other chronic weaknesses, problems, and perceptions of NEPA compliance include, for example, the following. NEPA compliance is expensive, cumbersome and complex, unfocused and encyclopedic, and time-consuming. It delays projects, is a target for litigation, and is a source of blame for agency environmental staff due to the ease of making a mistake. NEPA compliance is manipulated to justify decisions rather than being used to inform decisions. It is not used well for informing or involving the public and is not often useful for decision making. There is a need for a better way to implement, monitor, and manage environmental mitigation strategies. Further, NEPA compliance is often too focused on creating a legal document rather than enhancing the environment, contrary to the goals stated in Section 101 of the Act.

The International Organization for Standardization has published standard ISO 14001:2004 (“ISO 14001”) to provide generic requirements for an Environmental Management System (“EMS”). EMS is closely related to NEPA, but is not written by a governmental body and is not codified as law. The Presidential Council on Environmental Quality (CEQ) was created by NEPA and provides some guidance on integrating NEPA and EMS. Some agencies go further by setting additional goals. For example, the US Army created Army Strategy for the Environment (“ASE”), which has led to several NEPA-like processes, creating the Facility Sustainability Plan (“FSP”), and requiring Silver-level compliance with the green building certification called the Leadership in Energy and Environmental Design (“LEED”). All these processes are related and complementary. They also share some duplicative processes that could be combined to increase effectiveness and efficiency. Complying separately with NEPA, LEED, FSP, and EMS is costly in both dollars and time. There is a need for an innovative process that streamlines similar environmental, sustainability, and energy efficiency programs into one comprehensive system. The invention must integrate the compliance requirements of these myriad processes without diminishing or removing any in order to more effectively and efficiently comply with federal law, regulations, requirements, and guidance.

There is a need to integrate compliance with LEED and NEPA. The LEED process is similar to NEPA. Yet, most federal agencies have not effectively used LEED in their NEPA analyses. The LEED requirements are often very much related to NEPA mitigation requirements. The two are often considered duplicative but separate processes.

There is a need to integrate sets of requirements as they arise. There are many regulatory schemes related to environmentalism, sustainability, and energy efficiency, and new regulatory schemes are created from time to time. However, many of the regulatory schemes have requirements at least partially overlapping those of other regulatory schemes. Thus, there is a need to consolidate the requirements of each by allowing a user to select which environmental indicators to monitor and generating reports (annually or on-demand) including environmental indicators and analysis of a user's choosing so that a single report may be used to satisfy the requirements of multiple regulatory schemes.

The U.S. Environmental Protection Agency (“EPA”) has stated that there is no “cookbook” for proper cumulative impact analysis. U.S. Environmental Protection Agency, Office of Federal Activities, Consideration Of Cumulative Impacts In EPA Review of NEPA Documents[online], May 1999[retrieved on 2011-09-26]. Retrieved from the Internet: <URL: http://www.epa.gov/compliance/resources/policies/nepa/cumulative.pdf>. However, inadequate cumulative impact analysis is a weakness that increases risk of litigation.

There is an increased risk of litigation or project delay for inadequate or incomplete mitigation and monitoring. The CEQ recognizes that many agencies have inadequate NEPA mitigation and monitoring programs. The CEQ published guidance for NEPA mitigation and monitoring requirements. U.S. Environmental Protection Agency, Council on Environmental Quality, Appropriate Use of Mitigation and Monitoring and Clarifying the Appropriate Use of Mitigated Findings of No Significant Impact [online], Jan. 14, 2011 [retrieved 2011-09-26]. Retrieved from the Internet: <URL: http://ceq.hss.doe.gov/current_developments/docs/Mitigation_and_Monitoring_Guidance_{—}14Jan 2011.pdf>.

Accordingly, there is a need for a consolidated tracking system for compliance with NEPA and similar standards and regulations to solve the above weaknesses. There is a need for a mitigation tracking system and method configured to track implementation of mitigation measures, track audits of environmental compliance and performance, and generate reports via a computing system with an annual reporting.

### SUMMARY

The above problems, and others, are reduced by the Consolidated Annual Sustainability Tracking System (“CAST” or the “System”) as herein described and shown.

An object of an exemplary embodiment of the invention is to provide a System configured to integrate NEPA, EMS, LEED, FSP, and other complimentary processes into a report, which may be periodic, annual, or on-demand. The report complies with the regulatory requirements of each of the integrated processes. Reports may be “tiered,” meaning that the scope of one report may be nested within the scope of another. The narrower, tiered report incorporates the broader report by reference but concentrates on only a portion of the issues specific to the narrower report. The report in this exemplary embodiment may “tier” off of a broader plan for NEPA analysis. The broader plan may be a master or comprehensive plan. The report may report on past environmental and sustainability metrics, discuss upcoming plans, proposed actions for the future, and discuss any anticipated changes in environmental resources as a result of implementing those plans or proposed actions.

An object of an exemplary embodiment of the invention is to set sustainability and EMS goals through a public process by generating reports which can then be presented by a user to the public for feedback. The user can then utilize the feedback to further tailor subsequent reports.

An object of an exemplary embodiment of the invention is to identify thresholds of significance that trigger the need for an EIS by providing quantitative analysis of environmental indicators over time to empower a user to make educated decisions.

An object of an exemplary embodiment of the invention is to streamline inclusion of standard information. This standard information may include that unforeseen changes are not uncommon and that, in the event of an unforeseen change, the relevant agency or facility uses adaptive management to ensure that the changed plans and operations will not have a significant impact on interests related to environmentalism, sustainability, or energy efficiency. This standard information may be referred to as “boilerplate.”

An object of an exemplary embodiment of the invention is to employ adaptive management to adjust for unforeseen changes in projects or environmental effects.

An object of an exemplary embodiment of the invention is to generate an annual report with a draft FONSI for public distribution, review, and comment to comply with EMS and NEPA requirements relating to public involvement and federal agency requirements relating to transparency and public participation.

Other systems, methods, and/or products according to embodiments will be or become apparent to one with skill in the art upon review of the following drawings, and further description. It is intended that all such additional systems, methods, and/or products be included within this description, be within the scope of the present invention, and be protected by the accompanying claims.

### BRIEF DESCRIPTION OF THE DRAWINGS

The above and other exemplary embodiments, objects, uses, advantages, and novel features are more clearly understood by reference to the following description taken in connection with the accompanying figures wherein:

FIG. 1 illustrates a block diagram of an exemplary embodiment of CAST in accordance with some exemplary embodiments;

FIG. 2 illustrates a block diagram of another exemplary embodiment of CAST in accordance with some exemplary embodiments;

FIG. 3 illustrates a block diagram of still another exemplary embodiment of CAST in accordance with some exemplary embodiments;

FIG. 4 illustrates a block diagram of still another exemplary embodiment of CAST in accordance with some exemplary embodiments.

### DETAILED DESCRIPTION

The word “exemplary” is used herein to mean “serving as an example, instance, or illustration.” Any configuration or design described herein as “exemplary” is not necessarily to be construed as preferred or advantageous over other configurations or designs.

This invention now will be described more fully hereinafter with reference to the accompanying drawings, in which exemplary embodiments are shown. This invention may, however, be embodied in many different forms and should not be construed as limited to the embodiments set forth herein. Moreover, all statements herein reciting embodiments of the invention, as well as specific examples thereof, are intended to encompass both structural and functional equivalents thereof.

Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or perspective views illustrating some of this invention. The functions of the various elements shown in the figures may vary in shape, attachment, size, and other physical features. Those of ordinary skill in the art further understand that the exemplary systems, and/or methods described herein are for illustrative purposes and, thus, are not intended to be limited to any particular named manufacturer or other relevant physical limitation (e.g., material).

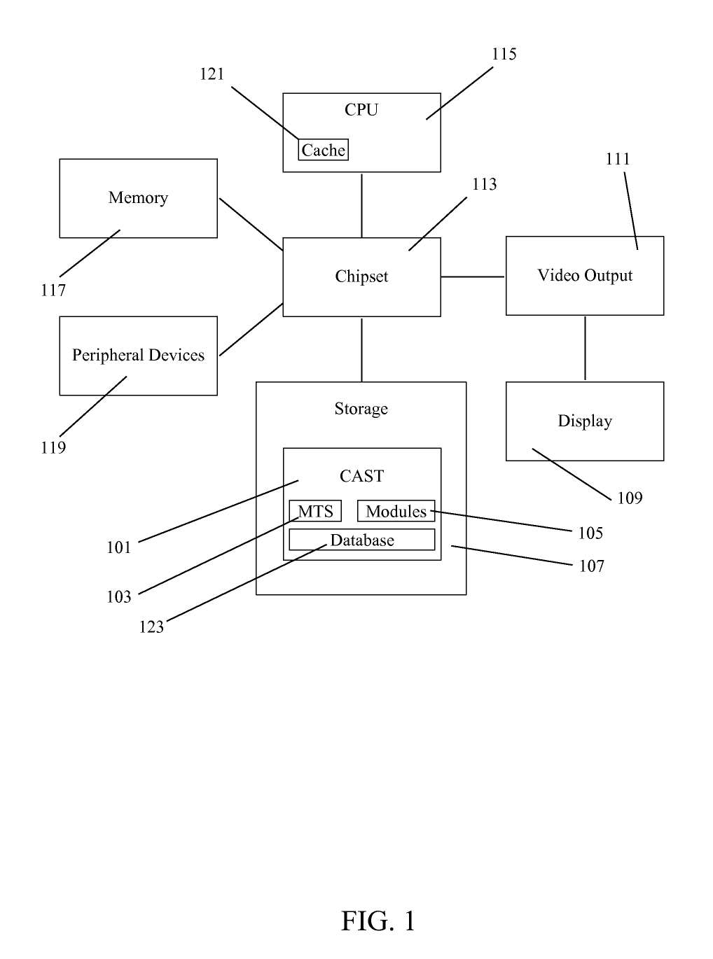

FIG. 1 illustrates a block diagram of an exemplary embodiment of CAST in accordance with some exemplary embodiments. CAST 101 runs as machine readable instructions on a computer comprising a chipset 113. Connected to the chipset 113 are storage 107, video output 111, central processor unit (“CPU”) 115, memory 117, and peripheral devices 119. The video output 111 controls the display 109, which presents information to a user in various forms, such as a graphical user interface (“GUI”). A GUI is well known in the art and are interactive to allow a user to present information to a user and record responses. Alternate interfaces could be used, such as audio- or text-based interface. CAST 101 stores records in a database 123. CAST 101 comprises a calendaring subsystem 103 which maintains a schedule of reminders based on data in a database 123. CAST 101 interfaces with and combines one or more modules 105. The modules 105 are sets of requirements, which may be generated from laws, regulations, requirements, or guidance such as may be found in NEPA, LEED, and EMS. CAST 101 combines the requirements of each module 105 to generate a consolidated set of requirements. New modules 105 may be loaded into CAST 101 to add additional sets of requirements. Upon loading a new module 105, CAST 101 updates the consolidated set of requirements.

Storage 107 may comprise a hard disk drive or solid-state drive with machine readable instructions. Storage 107 may comprise a computer readable medium such as a CD-ROM, floppy disk, hard disk drive, or removable solid-state drive with machine readable instructions. CAST 101 may be loaded from the storage 107 to the memory 117 during operation, or may run directly from the storage 107. CAST 101 may store a database on storage 107 or in memory 117. CAST 101 may be partially stored in a cache 121 associated with CPU 115.

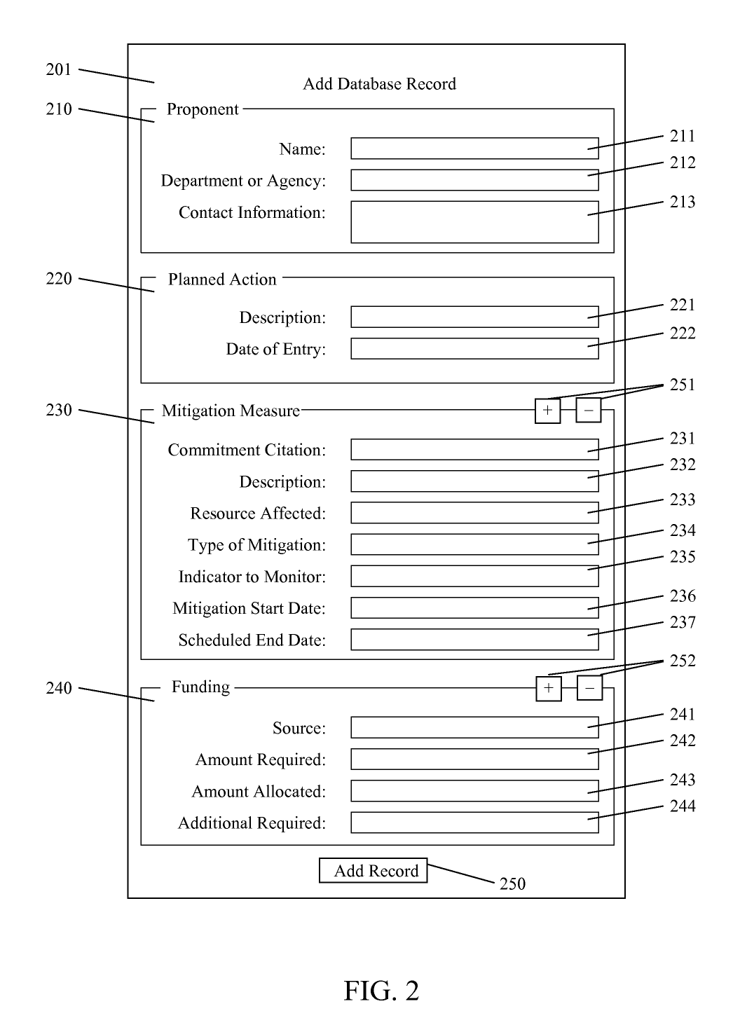

FIG. 2 illustrates a block diagram of another exemplary embodiment of CAST in accordance with some exemplary embodiments. In an exemplary embodiment, CAST presents a GUI 201 to a user to receive a plurality of data, the plurality of data being entered as a record into a database. The record includes data corresponding to a proponent 210, a planned action 220, zero or more mitigation measures 230, and funding 240.

The proponent data 210 includes a name of a proponent 211, a department or agency 212 the proponent is affiliated with, and contact information 213 for the proponent.

The planned action data 220 includes a description 221 and a date of entry 222. The date of entry is the date of the record's creation and may be entered by the user or automatically populated by CAST using the then-current date. A date in the past may be entered for the date of entry 222, which may indicate that the record is for an action which has already occurred. This feature allows the user to enter historical information into CAST.

The zero or more mitigation measures data 230 includes a commitment citation 231, a description 332, a resource affected 233, a type of mitigation 234, an indicator to monitor 235, a mitigation start date 236, and a scheduled end date 237. The indicator to monitor 235 includes a measurable value related to a natural resource, such as water pH, air particulate level, luminosity, water salinity, water turbidity, or any other qualitative or quantitative metric related to an environmental resource.

The commitment citation 231 field allows entry of the location in agency documentation where the agency committed to the mitigation measure. The commitment citation may be, for example, a specifically identified policy or an identification of a specific sentence on a specific page number of a specific document.

The description 332 field of the mitigation measure allows for text entry describing the mitigation measure. The resource affected 233 may be, for example, a natural resource such as air, water, soil, light, flora, or fauna.

The type of mitigation 234 field allows entry of text identifying the type of mitigation, including a construction project, a requirement to monitor, or other type of mitigation. A construction project may be, for example, a planting project to control erosion. A requirement to monitor may be, for example, a requirement to measure and monitor the level of carbon dioxide in the air at a specified location. The other type of mitigation may be, for example, a change in administrative policy or regulation.

The indicator to monitor 235 field allows entry of text identifying a measurable value related to a natural resource. The measureable value may include, for example, water pH, air particulate level, light luminosity, water salinity, water turbidity, flora biomass, or any other qualitative or quantitative metric related to an environmental resource.

The mitigation start date 236 field allows entry of a date identifying the date upon which the mitigation measure is scheduled to begin. The mitigation start date 236 may be a future date or a date in the past. If the mitigation start date 236 is in the past, the mitigation measure should have already begun.

The scheduled end date 237 field allows entry of a date identifying the date upon which the mitigation measure is scheduled to end. The scheduled end date 237 may be a future date or a date in the past. The mitigation start date 236 and scheduled end date 237 may be checked for validity by comparing them to one another. If the mitigation start date 236 and scheduled end date 237 are checked for validity, the mitigation start date 236 must precede the scheduled end date 237, or else both entries are found invalid. If the entries are found invalid, CAST will prompt the user to correct them.

The mitigation measure add and remove buttons 251 allow the user to control the number of mitigation measure about which to enter data. In this exemplary embodiment, add is symbolized using a plus symbol, while remove is symbolized using a minus symbol. CAST alters the GUI to allow entry of the appropriate number of mitigation measures responsive to a user interacting with the mitigation measure add and remove buttons 251.

The funding data 240 include information such as the funding source 241, the amount of funding required 242, the amount of funding allocated 243, and the amount of additional funding required 244. The funding source 241 field allows for entry of information identifying the source of the funding necessary to accomplish the zero or more mitigation measures 230. The funding data 240 may include a GUI element allowing a user to link a set of funding data 240 with one or more mitigation measures 230. The funding data 240 may include a GUI element allowing a user to limit a set of funding data to a specific time frame, such as a calendar year or fiscal year.

The amount of funding required 242 field allows entry of text identifying the dollar amount of funding required. The amount of funding required 242 field may allow entry of additional text identifying whether the dollar amount entered is required on a periodic basis, as a one-time cost, or as a total required amount. For example, the user may enter “$12,000 per fiscal year” in the amount of funding required 242 field to indicate that twelve thousand dollars is required each fiscal year. Alternatively, the user may enter “$2,000 by start date” to indicate that two thousand dollars is required by the start date entered in the mitigation start date 236 field.

The amount of funding allocated 243 field allows entry of text identifying the dollar amount of funding allocated. The amount of funding allocated 243 field may allow entry of additional text identifying whether the dollar amount entered is allocated on a periodic basis, as a one-time distribution, or as a total allocation amount. For example, the user may enter “$12,000 per fiscal year” in the amount of funding allocated 243 field to indicate that twelve thousand dollars is allocated per fiscal year. Alternatively, the user may enter “$2,000 total” to indicate that two thousand dollars is allocated for the entirety of the period spanning from the mitigation start date 236 to the scheduled end date 237.

The additional amount required 244 field may allow entry of text indicating how much additional funding is required or may display a calculated amount equaling the amount allocated 243 minus the amount required 242. The additional amount required 244 may be expressed as a per fiscal year figure or as a total figure.

The funding data add and remove buttons 252 allow the user to control the number of sets of funding data to enter. In this exemplary embodiment, add is symbolized using a plus symbol, while remove is symbolized using a minus symbol. CAST alters the GUI to allow entry of the appropriate number of sets of funding data responsive to the user interacting with the funding data add and remove buttons 252.

According to some embodiments, CAST creates a record in the database containing the information in the add database record 201 GUI responsive to a user interacting with the add record button 250.

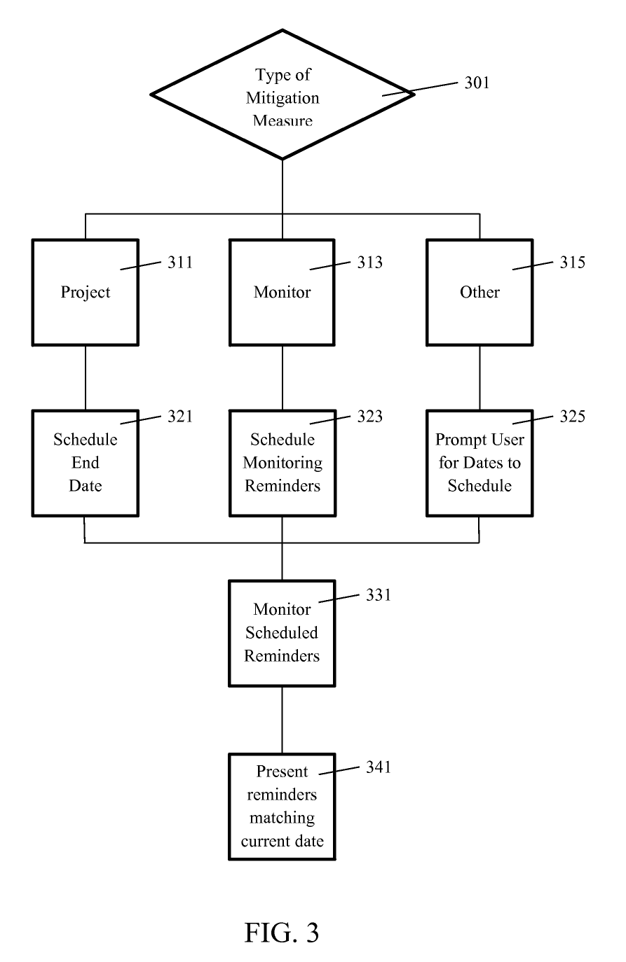

FIG. 3 illustrates a block diagram of still another exemplary embodiment of CAST in accordance with some exemplary embodiments. Responsive to entry of a new record, CAST may schedule reminders by making an entry in a calendar subsystem or in MTS. The type of reminder may depend on the type of mitigation measure 301 entered. For example, if the type of mitigation measure 301 is a project 311, CAST makes only one entry in the calendar subsystem, the one entry corresponding to the scheduled end date of the project 321. Alternatively, if the type of mitigation measure 301 is a requirement to monitor 313, CAST may make multiple entries into the calendar subsystem in order to provide recurring, periodic reminders to take and enter measurements in compliance with the requirement to monitor 323. Alternatively, if the type of mitigation measure 301 is other 315 than a project 311 or a requirement to monitor 313, then CAST may schedule no reminders or may prompt the user for dates upon which CAST schedules reminders 325.

CAST monitors all scheduled reminders 331 to determine if any are scheduled for a date matching the current date. If one or more scheduled reminders are scheduled for the current date, CAST presents the one or more scheduled reminders to the user 341.

For example, a record may be entered with a proposed activity being to construct a structure on a river's bank. The type of mitigation for a first mitigation measure is to monitor changes in the dissolved oxygen level of the river by comparing the dissolved oxygen level both upstream and downstream of the structure over time. Monitoring of each of the two sites must occur every month. The type of mitigation for a second mitigation measure is a project to build rip-rap along the shoreline to prevent erosion. Upon entry of the record into the database, CAST creates multiple entries in the calendar subsystem. In the calendar subsystem, a first reminder is scheduled on the scheduled end date of the rip-rap construction project. A second reminder is scheduled one month from the date of entry of the record, recurring each month thereafter. If the current date equals the date upon which one or more reminders are scheduled, CAST presents the one or more reminders to the user 341.

In order to prevent duplicative measurements of the same environmental indicator, CAST may schedule only one prompt to enter measurements of the environmental indicator if there are multiple records requiring monitoring data for the same indicator.

A user may disable a single reminder, all reminders within a date span, all reminders relating to a particular record, or all reminders relating to a particular environmental indicator. For instance, if a user determines that a particular environmental indicator no longer needs to be monitored, the user may disable all reminders relating to that environmental indicator. A disabled reminder will not be presented when the current date matches the date for which the reminder is scheduled 341.

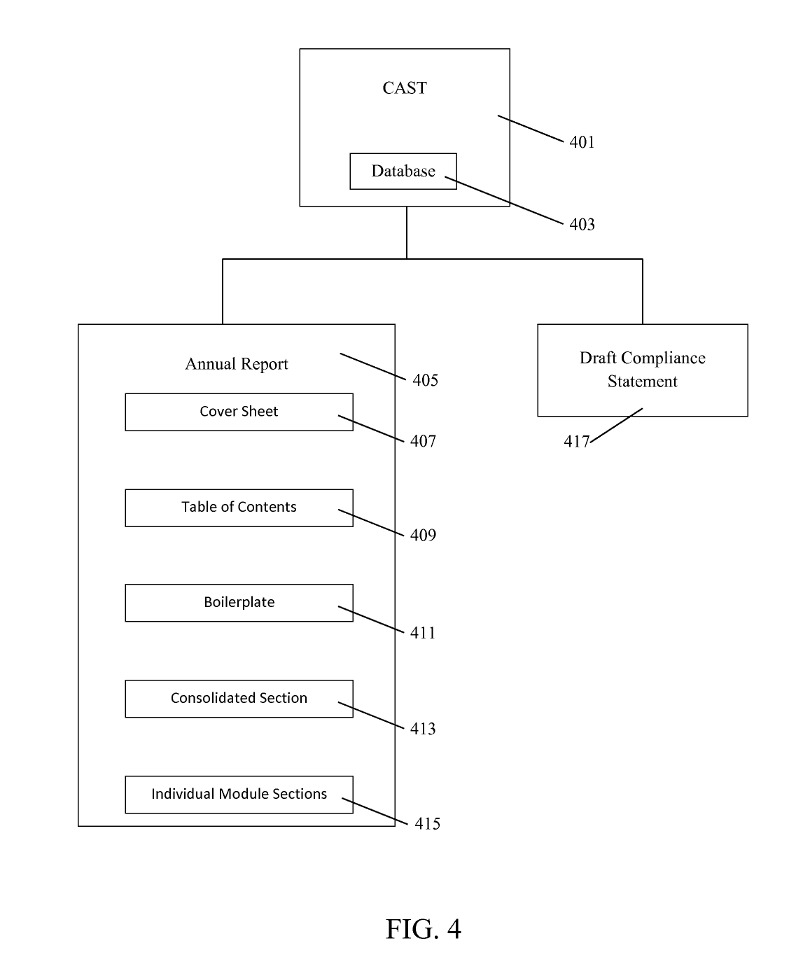

FIG. 4 illustrates a block diagram of still another exemplary embodiment of CAST in accordance with some exemplary embodiments. According to the exemplary embodiment, CAST 401 creates an annual report 405 using data stored in a database 403. CAST 401 selects all records in the database 403 for which the date of entry falls within the previous year. Each of the selected records contains data about planned actions. The annual report 405 includes information about relevant environmental indicators, a summary of the environmental impact of previous actions, and a projection of the environmental impact of planned actions. The annual report 405 comprises a cover sheet 407, a table of contents 409, boilerplate 411, a consolidated section 413, and zero or more individual module sections 415.

The cover sheet 407 comprises information identifying the annual report. CAST 401 generates the cover sheet using a pre-formatted template (not shown).

The table of contents 409 includes a list of environmental indicators relevant to the consolidated section 413 or to any of the zero or more individual module sections 415. Environmental indicators include, for example, air particulate level, water salinity, and water turbidity. However, a given environmental indicator may not be included in a given annual report 405. For instance, an annual report 405 for a landlocked geographic region will tend not to include environmental indicators relevant only to geographic regions with oceanic shoreline. Further, a user may disable a particular environmental indicator from appearing in the annual report 405. The environmental indicators may be organized into groups based on criteria. The criteria or criterion may be the resource to which the environmental indicators correspond, the regulation that requires tracking the environmental indicator, an arbitrary set of criteria, etc.

CAST 401 iterates through the records to generate a list of relevant environmental indicators, which excludes disabled environmental indicators. The list of relevant environmental indicators is generated by appending an environmental indicator to the list if it appears in any of the selected records as an environmental indicator to monitor. Alternatively, CAST 401 may concatenate all lists of environmental indicators to monitor from every selected record then remove all duplicate values to result in a list of unique values listing environmental indicators. Alternatively, CAST 401 may generate the list of relevant environmental indicators by any means of similar functionality.

In an exemplary embodiment, CAST 401 creates a consolidated section 413 of the annual report 405. Each record in the database 403 contains monitoring data about at least one environmental indicator. Each module contains a set of requirements, the set of requirements requiring inclusion of at least one environmental indicator. An environmental indicator is relevant to a module if the module contains a set of requirements which require monitoring of the environmental indicator. Environmental indicators which are relevant to more than one module are grouped into the consolidated section 413. Environmental indicators relevant to only one module are grouped into an individual module section 415 corresponding to the one module. Within the consolidated section 413 and each of the individual module sections 415, there are sub-sections for each environmental indicator.

The annual report may include all mitigation and monitoring data gathered for each relevant environmental indicator, organized to reflect the change of the environmental indicator over time. For example, if two actions required monitoring the level of phosphates in a body of water, the monitoring data for each action is plotted onto a graph with an axis representing time in order to show the phosphate level in that body of water over time. This graph is included on the annual report in a sub-section corresponding to the environmental indicator. The sub-section also includes data relating to each action.

A sub-section of the annual report may correspond to each relevant environmental indicator and may include a graph of the measurement data for the environmental indicator over the previous year, historical measurement data of the environmental indicator before the previous year, or a list of actions occurring in the past year that required monitoring of the environmental indicator.

CAST 401 generates zero or more draft compliance statements 417. The zero or more draft compliance statements 417 may be included as appendices to the annual report 405. The zero or more draft compliance statements 417 may include, for example, a draft FONSI. The draft FONSI may be a consolidated FONSI, meaning it may be a single FONSI document which applies to multiple planned actions, as opposed to having one FONSI document for each planned action. This draft FONSI may be presented to the public, after which it may be modified in light of commentary from the public and then finalized. CAST 401 may generate a single draft compliance statement 417 to satisfy the regulatory requirements of multiple regulatory schemes.

If a given environmental indicator did not significantly change over the course of the previous year, CAST generates a consolidated FONSI for all of the actions requiring monitoring of the environmental indicator. CAST may also create a statement conforming with a variety of other regulatory requirements, such as the Clean Air and Water Act, LEEDS, etc. The consolidated FONSI or other statements may be included in the annual report as an appendix.

While the invention has been particularly shown and described with references to a preferred embodiment thereof, it will be understood by those skilled in the art that various changes in form and details may be made therein without departing from the spirit and scope of the invention.

What is claimed is:

1. An apparatus that includes all patentable subject matter set forth in the application and drawings.

2. A system that includes all patentable subject matter set forth in the application and drawings.
